(19) United States
(12) Patent Application Publication
(10) Pub. No.: US 2010/0226950 A1
(43) Pub. Date: Sep. 9, 2010

(54) MICROENCAPSULATED INSECTICIDE WITH ENHANCED RESIDUAL ACTIVITY

(75) Inventor: Stephen L. Wilson, Indianapolis, IN (US)

Correspondence Address: DOW AGROSCIENCES LLC, 9330 ZIONSVILLE RD, INDIANAPOLIS, IN, 46268, US

(73) Assignee: DOW AGROSCIENCES LLC, Indianapolis, IN (US)

(21) Appl. No.: 12/714,890

(22) Filed: Mar. 1, 2010

Related U.S. Application Data
(60) Provisional application No. 61/157,297, filed on Mar. 4, 2009.

(51) Int. Cl. A01N 25/34; A01N 57/16; A01P 7/04

(52) U.S. Cl. 424/408; 514/89

(57) ABSTRACT

A method of formulating and using a microencapsulated insecticide with an extended field life after application of insecticidal activity. These methods include the steps of forming a microcapsule that includes at least one organophosphate insecticide and at least one non-volatile compound such as an esterified fatty acid that is at least partially surrounded by a polymer shell. These formulations can be used to control insect populations by singular or periodic applications of the microcapsule microencapsulated formulations to areas adjacent to insect populations.

### CROSS REFERENCE TO RELATED APPLICATIONS

This application claims the benefit of U.S. Provisional Patent Application Ser. No. 61/157,197, filed Mar. 4, 2009, which is expressly incorporated by reference herein.

### FIELD OF THE INVENTION

Various aspects and embodiments relate generally to formulations of microencapsulated pesticides that exhibit advantageous biological, commercial and/or environmental properties including long effective periods of insecticidal activity after their application.

### BACKGROUND

Controlling insect population is essential to modern agriculture, food storage and hygiene. Currently, encapsulated insecticidal formulations that are safe and effective play a significant role in controlling insect population. Properties of useful encapsulated insecticidal formulations include good efficacy against targeted pests, including good initial toxicity against targeted insects, ease of handling, stability, advantageous residence times in the environment and, in some instances, a long effective period of insecticidal activity after its application to an area adjacent to a population of insects.

Virtually all insecticidal formulations that lose their ability to kill or control insects must be reapplied resulting in increased material and labor costs. Additionally, formulations with a short period of post application activity can result in periods of time during which a surface adjacent to a population of insects is vulnerable to infestation. There is a need then, for insect formulations that retain their activity for extended periods of time after their application. Various aspects and embodiment disclosed herein address the need for insecticidal formulations which retain their ability to kill or repel insects for an extended period of time after they have been applied to a surface adjacent to a population of insects.

### SUMMARY

One embodiment of the invention is a method of formulating a microencapsulated insecticide in which the formulation retains its ability to kill or repel insects from a surface adjacent to a population of insects for at least 120 days after it is applied to the surface. One such method comprises the steps of: providing at least one insecticide, an esterified fatty acid, at least one monomer and a cross-linking agent; mixing the insecticide, the low volatility component and at least one monomer; and condensing the monomer to form a polymeric capsule shell that at least partially encapsulates a portion of the insecticide and a portion of the esterified fatty acid. In one embodiment the esterified fatty acid has Formula A, where A is:

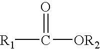

wherein; R₁ is a straight chain or branched alkyl, or alkenyl group having from 11 to 25 carbon atoms, and
R₂ is a straight chain or branched alkyl, or alkenyl group having from 1 to 8 carbon atoms.

In one embodiment of the invention the ingredient in the formulation with insecticidal activity is an organophosphate insecticide. In one embodiment the organophosphate insecticide is selected from the group consisting of: acephate, azinphos-methyl, chlorfenvinphos, chlorethoxyfos, chlorpyriphos, diazinon, dimethoate, disulfoton, ethoprophos, fenitrothion, fenthion, fenamiphos, fosthiazate, malathion, methamidophos, methidathion, omethoate, oxydemeton-methyl, parathion, parathion-methyl, phorate, phosmet, profenofos, and trichlorfon.

In still another embodiment the ingredient in the formulation that exhibits insecticidal activity is chlorpyrifos-methyl.

In one embodiment the formulation includes a microcapsule shell that at least partially encases an ingredient with insecticidal activity and is formed by an interfacial polycondensation of at least one monomer that is essentially insoluble in water and one monomer that is soluble in water. Oil soluble compounds that can be used to form the shell of the microcapsule may be selected from the group consisting of: diisocyanates, polyisocyanates, diacid chlorides, poly acid chlorides, sulfonyl chlorides, and chloroformates; water soluble monomer that can be used to form the shell can be selected from the group consisting of: diamines, polyamines, water soluble diols and water soluble polyols. In some embodiments the interfacial polycondensation step is carried out in the presence of a cross-linking agent such as an amine.

In one embodiment the esterified fatty acid in the formulation is methyl oleate.

One embodiment includes forming a microcapsule having a shell thickness of between about 90 nm to about 150 nm. In still another embodiment the microcapsule shell has a thickness of about 100 nm to about 130 nm. In yet another embodiment the microcapsule shell has a thickness of about 120 nm.

Still another embodiment is a method for controlling an insect population, comprising the steps of: providing an insecticidal formulation that retains its ability to kill or repel insects on a surface adjacent to a population of insects for at least 120 days and applying the formulation to a surface adjacent to an insect population. In still another embodiment the formulation retains its insecticidal activity or ability to repel insects for at least 150 days and in still another embodiment it retains its post application insecticidal activity for at least 170 days.

One embodiment is the method of controlling an insect population for an extended period of time following an application of the formulation, comprising the steps of providing an insecticidal formulation having a microcapsule shell or wall that at least partially surrounds a mixture including an insecticide and an esterified fatty acid (A), where:

### A is:

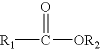

wherein; R₁ is a straight chain or branched alkyl, or alkenyl group having from 11 to 25 carbon atoms, and
R₂ is a straight chain or branched alkyl, or alkenyl group having from 1 to 8 carbon atoms.

In some embodiment the insecticide is an organophosphate insecticide and the capsule is formed via an interfacial polycondensation of a water soluble and a water insoluble monomer polymer. Additional steps include, for example, applying the formulation to a surface adjacent to a population of insects.

In one embodiment the method of controlling an insect population includes a microencapsulated formulation that comprises an organophosphate insecticide. In one embodiment the organophosphate insecticide is selected from the group consisting of: acephate, azinphos-methyl, chlorfenvinphos, chlorethoxyfos, chlorpyriphos, diazinon, dimethoate, disulfoton, ethoprophos, fenitrothion, fenthion, fenamiphos, fosthiazate, malathion, methamidophos, methidathion, omethoate, oxydemeton-methyl, parathion, parathion-methyl, phorate, phosmet, profenofos, and trichlorfon. In still another embodiment the organophosphate insecticide is chlorpyrifos-methyl.

In one embodiment the method of controlling an insect population includes the steps of applying a microencapsulated formulation of an insecticide in which the capsule wall is formed by an interfacial polycondensation between at least one oil soluble monomer selected from the group consisting of: diisocyanates, polyisocyanates, diacid chlorides, poly acid chlorides, sulfonyl chlorides, and chloroformates; and at least one water soluble monomer selected from the group consisting of: diamines, polyamines, water soluble diols and water soluble polyols and the polycondensation is carried out in the presence of an esterified fatty acid having Formula A, where:

### A is:

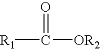

wherein; R₁ is a straight chain or branched alkyl, or alkenyl group having from 11 to 25 carbon atoms, and
R₂ is a straight chain or branched alkyl, or alkenyl group having from 1 to 8 carbon atoms.

In one embodiment, the formulation includes between about 3 to about 30 wt. percent of the esterified fatty acid. Still another embodiment is a method of controlling an insect population in an area adjacent to a population of insects for an extended period of time following an application of the insecticidal formulation, comprising the following steps: providing a microencapsulated insecticidal formulation that includes an esterified fatty acid according to Formula A in which the formulation continues to kill or repel insects for at least 120 days after its application. Yet another embodiment is a method for controlling an insect population in a given area that comprises the steps of: applying a microencapsulated insecticidal formulation in which the microcapsule has a shell thickness of between about 90 nm to about 150 nm and applying the microcapsule formulation to an area adjacent to a population of insects. In still another embodiment the microcapsule shell or wall has a thickness of about 120 nm.

In one embodiment the polymeric shell of the extended life insecticidal formulation is formed by cross-linking a water soluble monomer and a water insoluble monomer in the presence of amine such as diethylenetriamine, in the presence of an organophosphate insecticide and an esterified fatty acid.

Still another embodiment is an microencapsulated insecticidal formulation comprising, chlorpyrifos-methyl; methyl oleate; and a polymeric microcapsule shell, the shell comprising polyurea.

### DETAILED DESCRIPTION

For the purposes of promoting an understanding of the principles of the novel technology, reference will now be made to the preferred embodiments thereof, and specific language will be used to describe the same. It will nevertheless be understood that no limitation of the scope of the novel technology is thereby intended, such alterations, modifications, and further applications of the principles of the novel technology being contemplated as would normally occur to one skilled in the art to which the novel technology relates.

As used herein, the terms “shell” and “wall” are used interchangabley with reference to microcapsules unless otherwise noted. These terms do not necessarily imply that a given shell or wall is completely uniform or that it completely encompasses whichever materials or components that are localized within the corresponding microcapsule.

The term “about” implies a range of values plus or minus 20 percent e.g. about 1.0 includes values from 0.8 to 1.2 and all values within this range.

The need to periodically apply various insecticidal formulations in order to control continuing pest infestations or to prevent their occurrence, increase the amount of insecticides that must be used and the cost associated with their shipping, handling and application. Unfortunately, most insecticides, especially liquid based preparations, lose their efficacy relatively soon after their application and must be re-applied to insure insect control. Accordingly, methods of formulating insecticides that increase their post application effective lifetime provide a significant benefit to those industries and individuals that rely on pesticides to control insect populations.

Methods for extending the post application activity span of insecticides include providing and applying powders or crystals of the active ingredients to areas adjacent to insect populations or to areas susceptible to insect infestation. Not all useful insecticides are amenable to these approaches and some very useful insecticides are most effective in a liquid or pseudo liquid form. Even when the compound is active in crystalline or powder form, there are some situations in which dry formulations have their own limitation, including an increased tendency for inadvertent dispersal by wind or rain or a tendency to fall to the ground and off various elevated surfaces such as leaves, stems and flowering bodies where the compound is likely to exhibit its greatest utility. Another approach is to encapsulate the active ingredient in a formulation intended to somewhat protect the active ingredient from desiccation, dilution and/or unintended dispersal. Again, many of the currently available encapsulated formulations of various insecticides still loss activity relatively soon after their application to an area adjacent to a population of insects.

Various methods for formulating and using microencapsulated insecticidal formulations disclosed herein address this need by at least partially encapsulating the active insecticide in the formulation in a microcapsule along with a nonvolatile compound such as an esterified fatty acid. One group of insecticides that benefit from these types of formulations is the organophosphates. This class of insecticides includes, but is not limited to, acephate, azinphos-methyl, chlorfenvinphos, chlorethoxyfos, chlorpyriphos, diazinon, dimethoate, disulfoton, ethoprophos, fenitrothion, fenthion, fenamiphos, fosthiazate, malathion, methamidophos, methidathion, omethoate, oxydemeton-methyl, parathion, parathion-methyl, phorate, phosmet, profenofos, and trichlorfon. One especially useful organophosphate insecticide that benefits from being included in a microcapsule formulation that includes a nonvolatile component is chlorpyriphos-methyl.

As illustrated in Table 1, formulations of insecticides such as chlorpyrifos-methyl can be incorporated in microcapsules by forming the capsule in the presence of an inert liquid such as an esterified fatty acid, soybean oil, or polyglycol. Various formulations made either with or without methyl oleate were synthesized by methods presented in the experimental section.

Formulations of organophosphate insecticides, such as microencapsulated chlorpyrifos-methyl, generally lose their activity after their application.

TABLE 1
Compositions of representative formulations, based on the ingredients used to
formulate the microcapsule.

| | Lot Number | | | | | |
|---|---|---|---|---|---|---|
| | A | B | C | D | E | F |
| Target capsule | 12 | 12 | 12 | 12 | 12 | 12 |
| diameter (μm) | | | | | | |
| Target capsule wall | 120 | 80 | 120 | 80 | 120 | 120 |
| thickness (nm) | | | | | | |
| Chlorpyrifos-methyl (g) | 480 | 486.67 | 96.48 | 97.82 | 96.48 | 96.48 |
| 1-Nonanal (g) | 9.6 | 9.73 | 1.93 | 1.96 | 1.93 | 1.93 |
| Solvesso 150 (g) | 470.4 | 476.93 | 94.55 | 95.86 | 94.55 | 94.55 |
| Methyl Oleate (g) | — | — | 95.04 | 96.36 | — | — |
| Soybean Oil (g) | — | — | — | — | 95.04 | — |
| Polyglycol P-2000 (g) | — | — | — | — | — | 95.04 |
| PAPI 27 (g) | 40.00 | 26.67 | 12.00 | 8.00 | 12.00 | 12.00 |
| Diethylenetriamine (g) | 10.99 | — | 3.30 | — | 3.30 | 3.30 |
| Ethylenediamine (g) | — | 6.40 | — | 1.92 | | |
| Gohsenol GL03 (g) | 25.00 | 25.00 | 7.50 | 7.50 | 7.50 | 7.50 |
| Veegum (g) | 13.00 | 13.00 | 3.90 | 3.90 | 3.90 | 3.90 |
| Kelzan S (g) | 1.62 | 1.62 | 0.49 | 0.49 | 0.49 | 0.49 |
| Atlox 4913 (g) | 13.91 | 13.91 | 4.17 | 4.17 | 4.17 | 4.17 |
| Water (g) | 1087.48 | 1130.06 | 317.80 | 305.40 | 317.80 | 317.80 |
| Measured capsule | 11.3 | 11.8 | 11.4 | 11.8 | 12.2 | 11.6 |
| diameter (μm) | | | | | | |

Key to trade names and abbreviations used in Table 1.
Solvesso 150- Xylene-range aromatic solvent, Exxon
Polyglycol P-2000- Poly(propylene glycol), Dow Chemical
PAPI 27- polymethylene polyphenylisocyanate, Dow Chemical
Gohsenol GL03- poly(vinyl alcohol), Nippon Gohsei
Veegum- bentonite clay, R. T. Vanderbilt
Kelzan S- xathan gum, Kelco
Atlox 4913- polymeric surfactant, Croda

Referring now to Table 2, the sizes of these microcapsules were measured and they were assigned a one letter code. Next, these formulations were then applied to surfaces adjacent to insect populations, in order to measure their effectiveness.

TABLE 2
Chlorypyrifos-methyl microcapsules formulated
with and without nonvolatile solvents.

| | | | Particle | Wall |
|---|---|---|---|---|
| Formulation | | | Size | Thickness |
| ID. | Solvent(s) | Amine | (VMD, μm) | (nm) |
| A | Solvesso 150 | DETA | 12 | 120 |
| B | Solvesso 150 | EDA | 12 | 80 |
| C | methyl oleate, | DETA | 12 | 120 |
| | Solvesso 150 | | | |
| D | methyl oleate, | EDA | 12 | 80 |
| | Solvesso 150 | | | |
| E | soybean oil, | DETA | 12 | 120 |
| | Solvesso 150 | | | |
| H | soybean oil, | EDA | 12 | 80 |
| | Solvesso 150 | | | |
| F | polyglycol P-2000, | DETA | 12 | 120 |
| | Solvesso 150 | | | |
| I | polyglycol P-2000, | EDA | 12 | 80 |
| | Solvesso 150 | | | |

A qualitative summary of some components of microcapsule formulations of insecticide formed with, and without, inert non-volatile components such as soybean oil, polyglycol, or esterified fatty acids.

TABLE 3
Application Data, including the dilution of the formulation made
prior to its application and the application rate of the formulation
used to test various formulations on various surfaces.

| | | Amount of sample | Application |
|---|---|---|---|
| Formulation | Formulation | added to water | rate |
| ID | g/l C-M | ml | ml/m² |
| A | 240 | 4.17 in 45.83 | 50 ml |
| B | 240 | 4.17 in 45.83 | |
| C | 150 | 6.67 in 43.33 | |
| D | 150 | 6.67 in 43.33 | |
| E | 150 | 6.67 in 43.33 | |
| F | 150 | 6.67 in 43.33 | |
| G | 750 g/kg | 2.68 g made up to 50 ml | |
| Untreated control | — | — | |

In order to test the efficacy of the microencapsulated formulations disclosed herein these formulations along with control formulations were applied to the following surfaces, gypsum, wood and mud. These formulations, along with control formulations, were monitored for their activity against a species of mosquito, Anopheies arbaiensis. These studies were carried-out over about a 170 day time period, data collected in these tests are presented in Tables 4-8, and summarized in Table 9.

TABLE 4
Mortality Results Anopheles arabiensis.

| | | | Knockdown counts | | | | | Mortality counts | | | | |
|---|---|---|---|---|---|---|---|---|---|---|---|---|
| | | | Out of 15 | | | | | Out of 15 | | | | |
| | | | Replicates | | | | Total | Replicates | | | | Total |
| Period | Test | Sample | After 30 min. | | | | out | After 24 hours | | | | Out |
| after treatment | surface | code | 1 | 2 | 3 | 4 | of 60 | 1 | 2 | 3 | 4 | of 60 |
| 1 day | Gypsum | A | 2 | 4 | 3 | 1 | 10 | 15 | 15 | 15 | 15 | 60 |
| | | B | 11 | 13 | 12 | 10 | 46 | 15 | 15 | 15 | 15 | 60 |
| | | C | 4 | 9 | 7 | 9 | 29 | 15 | 15 | 15 | 15 | 60 |
| | | D | 14 | 15 | 14 | 13 | 56 | 15 | 15 | 15 | 15 | 60 |
| | | E | 4 | 5 | 3 | 6 | 18 | 15 | 15 | 15 | 15 | 60 |
| | | F | 14 | 14 | 15 | 14 | 57 | 15 | 15 | 15 | 15 | 60 |
| | | G | 12 | 13 | 11 | 16 | 51 | 15 | 15 | 15 | 15 | 60 |
| | | Control | — | — | — | — | — | 1 | 0 | 0 | 3 | 4 |
| | Wood | A | 10 | 9 | 28 | 7 | 34 | 15 | 15 | 15 | 15 | 60 |
| | | B | 12 | 13 | 11 | 15 | 51 | 15 | 15 | 15 | 15 | 60 |
| | | C | 8 | 9 | 7 | 10 | 34 | 15 | 15 | 15 | 15 | 60 |
| | | D | 12 | 13 | 13 | 14 | 52 | 15 | 15 | 15 | 15 | 60 |
| | | E | 14 | 10 | 12 | 11 | 47 | 15 | 15 | 15 | 15 | 60 |
| | | F | 15 | 14 | 15 | 15 | 59 | 15 | 15 | 15 | 15 | 60 |
| | | G | 10 | 13 | 11 | 10 | 44 | 15 | 15 | 15 | 15 | 60 |
| | | Control | — | — | — | — | — | 0 | 1 | 1 | 1 | 3 |
| 1 day | Mud | A | 2 | 4 | 3 | 1 | 10 | 15 | 15 | 15 | 15 | 60 |
| | | B | 11 | 13 | 12 | 10 | 46 | 15 | 15 | 15 | 15 | 60 |
| | | C | 4 | 9 | 7 | 9 | 29 | 15 | 15 | 15 | 15 | 60 |
| | | D | 14 | 16 | 14 | 13 | 56 | 15 | 15 | 15 | 15 | 60 |
| | | E | 4 | 5 | 3 | 6 | 18 | 15 | 15 | 15 | 15 | 60 |
| | | F | 14 | 14 | 15 | 14 | 57 | 15 | 15 | 15 | 15 | 60 |
| | | G | 12 | 13 | 11 | 15 | 51 | 15 | 15 | 15 | 15 | 60 |
| | | Control | — | — | — | — | — | 1 | 0 | 0 | 3 | 4 |

Mortality results measured against Anopheles arabiensis, determined 1 day after the application of the formulation to an area that includes the pest.

TABLE 5
Mortality Results Anopheles arabiensis.

| | | | Knockdown counts | | | | | Mortality counts | | | | |
|---|---|---|---|---|---|---|---|---|---|---|---|---|
| | | | Out of 15 | | | | | Out of 15 | | | | |
| | | | Replicates | | | | Total | Replicates | | | | Total |
| Period | Test | Sample | After 30 min. | | | | out | After 24 hours | | | | Out |
| after treatment | surface | code | 1 | 2 | 3 | 4 | of 60 | 1 | 2 | 3 | 4 | of 60 |
| 1 month | Gypsum | A | 0 | 0 | 0 | 0 | 0 | 15 | 15 | 15 | 15 | 60 |
| | | B | 0 | 0 | 0 | 0 | 0 | 15 | 15 | 15 | 15 | 60 |
| | | C | 0 | 0 | 0 | 0 | 0 | 15 | 15 | 15 | 15 | 60 |
| | | D | 2 | 0 | 3 | 1 | 6 | 15 | 15 | 15 | 15 | 60 |
| | | E | 0 | 0 | 0 | 0 | 0 | 15 | 15 | 15 | 15 | 60 |
| | | F | 0 | 0 | 0 | 0 | 0 | 15 | 15 | 15 | 15 | 60 |
| | | G | 2 | 1 | 2 | 2 | 7 | 15 | 15 | 15 | 15 | 60 |
| | | Control | — | — | — | — | — | 0 | 2 | 1 | 2 | 5 |
| | Wood | A | 0 | 0 | 0 | 0 | 0 | 15 | 15 | 15 | 15 | 60 |
| | | B | 0 | 0 | 0 | 0 | 0 | 15 | 15 | 15 | 15 | 60 |
| | | C | 0 | 0 | 0 | 0 | 0 | 15 | 15 | 15 | 15 | 60 |
| | | D | 3 | 5 | 4 | 2 | 14 | 15 | 15 | 15 | 15 | 60 |
| | | E | 0 | 0 | 0 | 0 | 0 | 15 | 15 | 15 | 15 | 60 |
| | | F | 0 | 0 | 0 | 0 | 0 | 15 | 15 | 15 | 15 | 60 |
| | | G | 0 | 0 | 0 | 0 | 0 | 15 | 15 | 15 | 15 | 60 |
| | | Control | — | — | — | — | — | 1 | 1 | 1 | 3 | 6 |
| 1 month | Mud | A | 0 | 0 | 0 | 0 | 0 | 13 | 15 | 7 | 9 | 44 |
| | | B | 0 | 0 | 0 | 0 | 0 | 6 | 15 | 9 | 4 | 34 |
| | | C | 0 | 0 | 0 | 0 | 0 | 15 | 6 | 15 | 15 | 51 |
| | | D | 0 | 0 | 0 | 0 | 0 | 7 | 3 | 2 | 0 | 12 |
| | | E | 0 | 0 | 0 | 0 | 0 | 6 | 13 | 15 | 12 | 46 |
| | | F | 0 | 0 | 0 | 0 | 0 | 10 | 1 | 0 | 0 | 11 |
| | | G | 0 | 0 | 0 | 0 | 0 | 15 | 14 | 12 | 15 | 56 |
| | | Control | — | — | — | — | — | 0 | 0 | 1 | 2 | 3 |

Mortality results measured against Anopheles arabiensis, determined 1 month after the application of the formulation to an area that includes the pest.

TABLE 6
Mortality Results Anopheles arabiensis.

| | | | Knockdown counts | | | | | Mortality counts | | | | |
|---|---|---|---|---|---|---|---|---|---|---|---|---|
| | | | Out of 15 | | | | | Out of 15 | | | | |
| | | | Replicates | | | | Total | Replicates | | | | Total |
| Period | Test | Sample | After 30 min. | | | | out | After 24 hours | | | | Out |
| after treatment | surface | code | 1 | 2 | 3 | 4 | of 60 | 1 | 2 | 3 | 4 | of 60 |
| 2 months | Gypsum | A | 0 | 0 | 0 | 0 | 0 | 15 | 15 | 15 | 15 | 60 |
| | | B | 0 | 0 | 0 | 0 | 0 | 15 | 15 | 15 | 15 | 60 |
| | | C | 0 | 0 | 0 | 0 | 0 | 15 | 15 | 15 | 15 | 60 |
| | | D | 2 | 0 | 3 | 1 | 6 | 15 | 15 | 15 | 15 | 60 |
| | | E | 0 | 0 | 0 | 0 | 0 | 15 | 15 | 15 | 15 | 60 |
| | | F | 0 | 0 | 0 | 0 | 0 | 15 | 15 | 15 | 15 | 60 |
| | | G | 2 | 1 | 2 | 2 | 7 | 15 | 15 | 15 | 15 | 60 |
| | | Control | — | — | — | — | — | 1 | 0 | 1 | 1 | 3 |
| | Wood | A | 0 | 0 | 0 | 0 | 0 | 15 | 15 | 15 | 15 | 60 |
| | | B | 0 | 0 | 0 | 0 | 0 | 15 | 15 | 15 | 15 | 60 |
| | | C | 0 | 0 | 0 | 0 | 0 | 15 | 15 | 15 | 15 | 60 |
| | | D | 3 | 5 | 4 | 2 | 14 | 15 | 15 | 15 | 15 | 60 |
| | | E | 0 | 0 | 0 | 0 | 0 | 15 | 15 | 15 | 15 | 60 |
| | | F | 0 | 0 | 0 | 0 | 0 | 15 | 15 | 15 | 15 | 60 |
| | | G | 0 | 0 | 0 | 0 | 0 | 15 | 15 | 15 | 15 | 60 |
| | | Control | — | — | — | — | — | 0 | 2 | 1 | 0 | 3 |
| 2 months | Mud | A | 0 | 0 | 0 | 0 | 0 | 9 | 15 | 9 | 12 | 45 |
| | | C | 0 | 0 | 0 | 0 | 0 | 11 | 12 | 15 | 13 | 51 |
| | | E | 0 | 0 | 0 | 0 | 0 | 8 | 9 | 15 | 15 | 47 |
| | | G | 0 | 0 | 0 | 0 | 0 | 13 | 10 | 9 | 13 | 45 |
| | | Control | — | — | — | — | — | 0 | 2 | 1 | 2 | 5 |

Mortality results measured against Anopheles arabiensis, determined 2 months after the application of the formulation to an area that includes the pest.

TABLE 7
Mortality Results Anopheles arabiensis.

| | | | Knockdown counts | | | | | Mortality counts | | | | |
|---|---|---|---|---|---|---|---|---|---|---|---|---|
| | | | Out of 15 | | | | | Out of 15 | | | | |
| | | | Replicates | | | | Total | Replicates | | | | Total |
| Period | Test | Sample | After 30 min. | | | | out | After 24 hours | | | | Out |
| after treatment | surface | code | 1 | 2 | 3 | 4 | of 60 | 1 | 2 | 3 | 4 | of 60 |
| 4 months | Gypsum | A | 0 | 0 | 0 | 0 | 0 | 14 | 12 | 13 | 10 | 49 |
| | | B | 0 | 0 | 0 | 0 | 0 | 15 | 15 | 15 | 15 | 60 |
| | | C | 0 | 0 | 0 | 0 | 0 | 15 | 15 | 15 | 15 | 60 |
| | | D | 2 | 0 | 3 | 1 | 6 | 3 | 7 | 4 | 5 | 18 |
| | | E | 0 | 0 | 0 | 0 | 0 | 8 | 10 | 5 | 9 | 32 |
| | | F | 0 | 0 | 0 | 0 | 0 | 10 | 14 | 10 | 13 | 47 |
| | | G | 2 | 1 | 2 | 2 | 7 | 15 | 15 | 15 | 15 | 60 |
| | | Control | — | — | — | — | — | 0 | 1 | 1 | 1 | 3 |
| | Wood | A | 0 | 0 | 0 | 0 | 0 | 3 | 2 | 5 | 3 | 13 |
| | | B | 0 | 0 | 0 | 0 | 0 | 15 | 15 | 15 | 15 | 60 |
| | | C | 0 | 0 | 0 | 0 | 0 | 15 | 15 | 15 | 15 | 60 |
| | | D | 0 | 0 | 0 | 0 | 0 | 1 | 4 | 2 | 3 | 10 |
| | | E | 0 | 0 | 0 | 0 | 0 | 4 | 11 | 6 | 8 | 29 |
| | | F | 0 | 0 | 0 | 0 | 0 | 2 | 1 | 6 | 3 | 12 |
| | | G | 0 | 0 | 0 | 0 | 0 | 15 | 14 | 14 | 15 | 58 |
| | | Control | — | — | — | — | — | 0 | 1 | 0 | 1 | 2 |
| 4 months | Mud | A | 0 | 0 | 0 | 0 | 0 | 2 | 3 | 3 | 7 | 15 |
| | | C | 0 | 0 | 0 | 0 | 0 | 8 | 6 | 4 | 3 | 21 |
| | | E | 0 | 0 | 0 | 0 | 0 | 2 | 3 | 2 | 1 | 8 |
| | | G | 0 | 0 | 0 | 0 | 0 | 7 | 11 | 5 | 8 | 31 |
| | | Control | 0 | 0 | 0 | 0 | 0 | 2 | 2 | 0 | 1 | 5 |

Mortality results measured against Anopheles arabiensis, determined 4 months after the application of the formulation to an area that includes the pest.

TABLE 8
Mortality Results Anopheles arabiensis.

| | | | Knockdown counts | | | | | Mortality counts | | | | |
|---|---|---|---|---|---|---|---|---|---|---|---|---|
| | | | Out of 15 | | | | | Out of 15 | | | | |
| | | | Replicates | | | | Total | Replicates | | | | Total |
| Period | Test | Sample | After 30 min. | | | | out | After 24 hours | | | | Out |
| after treatment | surface | code | 1 | 2 | 3 | 4 | of 60 | 1 | 2 | 3 | 4 | of 60 |
| 5 months | Gypsum | A | 0 | 0 | 0 | 0 | 0 | 9 | 7 | 11 | 10 | 37 |
| 3 weeks | | B | 0 | 0 | 0 | 0 | 0 | 10 | 6 | 9 | 13 | 38 |
| | | C | 0 | 0 | 0 | 0 | 0 | 15 | 15 | 15 | 15 | 60 |
| | | F | 0 | 0 | 0 | 0 | 0 | 3 | 3 | 2 | 1 | 9 |
| | | G | 0 | 0 | 0 | 0 | 0 | 15 | 15 | 15 | 15 | 60 |
| | | Control | — | — | — | — | — | 1 | 0 | 2 | 1 | 4 |
| | Wood | A | 0 | 0 | 0 | 0 | 0 | 5 | 9 | 8 | 6 | 28 |
| | | B | 0 | 0 | 0 | 0 | 0 | 14 | 15 | 15 | 15 | 59 |
| | | C | 0 | 0 | 0 | 0 | 0 | 15 | 1 | 15 | 15 | 60 |
| | | G | 0 | 0 | 0 | 0 | 0 | 15 | 14 | 15 | 15 | 59 |
| | | Control | — | — | — | — | — | 1 | 0 | 1 | 0 | 2 |
| 5 months | Mud | A | 0 | 0 | 0 | 0 | 0 | 4 | 1 | 2 | 3 | 10 |
| 3 weeks | | B | 0 | 0 | 0 | 0 | 0 | 3 | 7 | 1 | 2 | 13 |
| | | C | 0 | 0 | 0 | 0 | 0 | 5 | 8 | 6 | 4 | 23 |
| | | Control | 0 | 0 | 0 | 0 | 0 | 0 | 1 | 1 | 3 | 5 |

Mortality results measured against Anopheles arabiensis, determined 5 months and 3 weeks after the application of the formulation to an area that includes the pest.

TABLE 9

| | | | | Particle | Wall | | | | |
|---|---|---|---|---|---|---|---|---|---|
| | | | | Size | Thickness | 30 | 60 | 120 | 170 |
| | | Solvent(s) | Amine | (VMD, μm) | (nm) | days | days | days | days |
| Gypsum | A | Solvesso 150 | DETA | 12 | 120 | 60 | 60 | 49 | 37 |
| | B | Solvesso 150 | EDA | 12 | 80 | 60 | 60 | 60 | 38 |
| | C | methyl oleate, | DETA | 12 | 120 | 60 | 60 | 60 | 60 |
| | | Solvesso 150 | | | | | | | |
| | D | methyl oleate, | EDA | 12 | 80 | 60 | 60 | 18 | — |
| | | Solvesso 150 | | | | | | | |
| | E | soybean oil, | DETA | 12 | 120 | 60 | 60 | 32 | — |
| | | Solvesso 150 | | | | | | | |
| | F | polyglycol | DETA | 12 | 120 | 60 | 60 | 47 | — |
| | | P-2000, | | | | | | | |
| | | Solvesso 150 | | | | | | | |
| Wood | A | Solvesso 150 | DETA | 12 | 120 | 60 | 60 | 13 | 28 |
| | B | Solvesso 150 | EDA | 12 | 80 | 60 | 60 | 60 | 59 |
| | C | methyl oleate, | DETA | 12 | 120 | 60 | 60 | 60 | 60 |
| | | Solvesso 150 | | | | | | | |
| | D | methyl oleate, | EDA | 12 | 80 | 60 | 60 | 10 | — |
| | | Solvesso 150 | | | | | | | |
| | E | soybean oil, | DETA | 12 | 120 | 60 | 60 | 29 | — |
| | | Solvesso 150 | | | | | | | |
| | F | polyglycol P- | DETA | 12 | 120 | 60 | 60 | 12 | — |
| | | 2000, | | | | | | | |
| | | Solvesso 150 | | | | | | | |
| Mud | A | Solvesso 150 | DETA | 12 | 120 | 44 | 45 | 15 | 10 |
| | B | Solvesso 150 | EDA | 12 | 80 | 34 | — | — | 13 |
| | C | methyl oleate, | DETA | 12 | 120 | 51 | 21 | 21 | 23 |
| | | Solvesso 150 | | | | | | | |
| | D | methyl oleate, | EDA | 12 | 80 | 12 | — | — | — |
| | | Solvesso 150 | | | | | | | |
| | E | soybean oil, | DETA | 12 | 120 | 46 | 8 | 8 | — |
| | | Solvesso 150 | | | | | | | |
| | F | polyglycol P- | DETA | 12 | 120 | 11 | — | — | — |
| | | 2000, | | | | | | | |
| | | Solvesso 150 | | | | | | | |

Summary of residual insecticidal activity measured using mosquitoes. These values were determined after the application of different microcapsule formulations that include an organophosphate insecticide such as chlorpyrifos-methyl. Some of the formulations included an esterified fatty acid while the other formulations do not include this compound.

Referring now to Table 9, of all of the formulations tested, the formulations with the longest effective periods of post application activity included esterified fatty acids. The other non-volatile components, such as soybean oil and polyglycol, did not extend the effective field life of the insecticide to the same extent as did the esterified fatty acids. These results demonstrate that the addition of an esterified fatty acid to a microcapsule that includes an organophosphate insecticide creates a microcapsule formulation that retains it insecticidal activity for upwards of 150 days after its application.

### Experimental

### Materials and Methods

### Preparation of Microcapsule Suspensions

Referring now to Table 1, amounts of the components used to synthesize representative for capsule suspension are summarized in Table 1. The procedure followed to prepare for the compounds listed in Table 1 was as follows. Different formulations were made by changing the composition of the reaction mixture. An organic phase was prepared by combining the indicated amount of PAPI 27 isocyanate monomer (Dow Chemical) with a 50 wt. % solution of chlorpyrifos-methyl in Solvesso 150, also containing 1-nonanal as a preservative. Methyl oleate, soybean oil, or Polyglycol P-2000, were included as indicated in Table 1. This mixture was swirled until homogeneous. An aqueous phase was prepared comprised of the indicated amounts of poly(vinyl alcohol) (PVA, Gohsenol GL03, Nippon Gohsei), Veegum® (R. T. Vanderbilt), and Kelzan S® (Kelco) with the amount of DI water indicated in Table 1 minus the amount utilized to prepare the 10% amine solution described below. This aqueous phase was added to the organic phase to give a two-phase mixture. This mixture was emulsified using a Silverson L4RT-A high-speed mixer using the standard mixing head assembly fitted with the emulsion sleeve. Emulsification was achieved by first mixing at relatively low speed (˜1000 rpm) with the tip of the mixing assembly located in the aqueous phase to draw in the organic phase until well emulsified. The speed was then increased in discrete increments. The mixer was stopped after each increase in speed and a size measurement taken. This process was continued until the desired particle size was obtained. A speed of ˜4500-7500 rpm was typically required to reach the desired size. The cross-linking amine (either diethylenetriamine (DETA) or ethylenediamine (EDA), Aldrich) was added dropwise as a 10% aqueous solution while stirring at a reduced speed that maintained good mixing. Following the completion of the amine addition, the resulting capsule suspension was stirred for an additional minute, the indicated amount of Atlox 4913 was added, and a final brief homogenization was performed to complete the preparation of the capsule suspension.

By carefully adjusting the length of time that the mixture is stirred and/or by adjusting the speed of the mixer, it is possible to produce encapsulated organophosphate insecticidal formulations of varying capsule size having a range of shell thicknesses. Similarly, the amounts of monomer, cross-linking agents, wetting agents, buffer, and the like can be adjusted to create microencapsulated organophosphate insecticidal formulations having varying capsule and shell thicknesses.

The final composition of the microcapsules is equivalent or eventually identified to the proportion of the materials used in their formation. Accordingly, the composition of these formulations is very similar, if not identical, to the composition of the reaction mixtures used to form them (Table 1).

### Measurement of Particle Size in Microcapsule Suspensions

Capsule suspension particle size distributions were determined using a Malvern Mastersizer 2000 light scattering particle sizer fitted with a small volume sample unit and using software version 5.12. Prior to measurement the samples were shaken or stirred well to insure homogeneity. The volume median distribution (VMD) is reported for each formulation in the Materials section above.

### Calculation of Capsule Wall Thickness

The calculation of the amounts of capsule wall components needed to achieve a target wall thickness was based on the geometric formula relating the volume of a sphere to its radius. If a core-shell morphology is assumed, with the core comprised of the non wall-forming, water insoluble components (chlorpyrifos, solvent) and the shell made up of the polymerizable materials (oil and water soluble monomers), then equation (1) holds, relating the ratio of the volume of the core (V_{S}) and the volume of the core, plus the volume of the shell (V_{S}) to their respective radii, where r_{S} is radius of the capsule including the shell and I_{S} is thickness of the shell.

$$\frac{{V}_{c} + {V}_{s}}{{V}_{c}} = {( \frac{{r}_{s}}{{r}_{s} - {l}_{s}} )}^{3} \qquad ( 1 )$$

Solving equation (1) for the volume of the shell yields:

$${V}_{S} = {V}_{C} ( {( \frac{{r}_{S}}{{r}_{S} - {l}_{S}} )}^{3} - 1 ) \qquad ( 2 )$$

Substituting masses (mᵢ) and densities (dᵢ) for their respective volumes (mₛ/dₛ=Vₛ and m_{c}/d_{c}=V_{c}, where the subscript s or c refers to the shell or core, respectively) and solving for the mass of the shell gives:

$${m}_{S} = {m}_{C} \frac{{d}_{S}}{{d}_{C}} ( {( \frac{{r}_{S}}{{r}_{S} - {l}_{S}} )}^{3} - 1 ) \qquad ( 3 )$$

In order to simplify the calculation and directly use the respective weights of the capsule core and shell components the approximation that the density ratio dₛ/d_{c} is approximately equal to one was made yielding equation (4).

$${m}_{S} \approx {m}_{C} ( {( \frac{{r}_{S}}{{r}_{S} - {l}_{S}} )}^{3} - 1 ) \qquad ( 4 )$$

Making the substitutions m_{C}=m_{O}−m_{OSM}, m_{S}=m_{O}+(f_{WSM/OSM)})m_{OSM}−m_{C}, and f_{WSM/OSM}=m_{WSM}/m_{OSM} (the ratio of water soluble monomer to oil soluble monomer), where m_{O} is the total mass of the oil components (Chloryprifos, solvent, oil-soluble monomer), m_{OSM} is the mass of the oil-soluble monomer, and m_{WSM} is the mass of the water-soluble monomer, and solving for m_{OSM} yields:

$${m}_{OSM} = \frac{{m}_{O} ( {( \frac{{r}_{S}}{{r}_{S} - {l}_{S}} )}^{3} - 1 )}{{f}_{WSM / OSM} + {( \frac{{r}_{S}}{{r}_{S} - {l}_{S}} )}^{3}} \qquad ( 5 )$$

For the determination of m_{OSM}, the entire quantity of m_{WSM} was used in the calculation as a convention. In the present study the water-soluble monomer was used on a 1:1 equivalent weight basis relative to the oil-soluble monomer for all of the capsule suspension preparations.

Listing of Various Formulations Synthesized and Tested, see also Table 1.

A includes 22.4% w/w (240 g/i) chlorpyrifos-methyl.

B includes 22.4% w/w (240 g/i) chlorpyrifos-methyl.

C includes 14.6% w/w (150 g/i) chlorpyrifos-methyl.

D includes 14.6% w/w (150 g/i) chlorpyrifos-methyl.

E includes 14.6% w/w (150 g/i) chlorpyrifos-methyl.

F includes 14.6% w/w (150 g/i) chlorpyrifos-methyl.

DDT-G includes 750 g/kg trichlorobis (chlorophenyl)ethane;

### Test Methods

Insect knockdown tests were carried out using a modified version of the WHO laboratory protocol. In these tests, female 1 day-5 day old malaria mosquitoes were used as test insects. The test surfaces used were mud from Nduma, Tanzania, wood and gypsum. The mud used in these tests was from the same mud source that is used to construct some huts in Nduma. The mud panels were made by mixing soil and tap water and placing it in plastic molds. The top was flattened and left to dry. Cracks that formed were filled with mud. The gypsum panels were made by mixing gypsum and tap water using the same or substantially the same moulds as were used to create the test mud surfaces. The samples of various formulation were diluted with tap water at the rates given in FIG. 3 Table 3 and were applied with an aerograph spray gun.

The gypsum and wood panels were sprayed and the first exposure was carried out the following day. The insect exposure tests were repeated using the same surfaces at the following intervals: one month, two months, four months, and five months 3 weeks (about 170 days). Due to the size of the test and the availability of female 1 day-5 day old malaria mosquitoes, the test was split into two runs.

During application of each sample, eight filter papers were also treated. These were placed in a deep freeze at −27° C. for analysis after the following storage periods, i.e., one day, one month, two months, four months, and five months three weeks after treatment. After each exposure, a knockdown count was taken and the mosquitoes were transferred to glass containers. The glass containers were covered with organdie and secured with an elastic band. A piece of cotton wool saturated with a 5% sugar solution was placed on top of the organdie as food. The re-exposures were conducted on those surfaces where a mortality of >70% was obtained in the previous exposure or as deemed necessary during the course of conducting these experiments.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

While the novel technology has been illustrated and described in detail in the figures and foregoing description, the same is to be considered as illustrative and not restrictive in character, it being understood that only the preferred embodiments have been shown and described and that all changes and modifications that come within the spirit of the novel technology are desired to be protected. As well, while the novel technology was illustrated using specific examples, theoretical arguments, accounts, and illustrations, these illustrations and the accompanying discussion should by no means be interpreted as limiting the technology. All patents, patent applications, and references to texts, scientific treatises, publications, and the like referenced in this application are incorporated herein by reference in their entirety.

1. A method of extending the effective field life of an insecticide, comprising the steps of:
providing at least one insecticide, at least one esterified fatty acid; at least one cross-linking agent and at least one type of monomer;
mixing the insecticide, the esterified fatty acid, the at least one cross-linking agent and at least one type of monomer; and
forming a polymeric microcapsule shell that at least partially encapsulates a portion of the insecticide and a portion of the esterified fatty acid to form a microencapsulated insecticidal formulation, wherein the microencapsulated insecticidal formulation retains its ability to control insects for at least 1 week after the formulation is applied to an area adjacent to a population of insects.

2. The method according to claim 1, wherein the esterified fatty acid is: 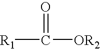
wherein;
R₁ is a straight chain or branched alkyl, or alkenyl group having from 11 to 25 carbon atoms, and R₂ is a straight chain or branched alkyl, or alkenyl group having from 1 to 8 carbon atoms.

3. The method according to claim 1, wherein the esterified fatty acid is methyl oleate.

4. The method according to claim 1, wherein the insecticide is an organophosphate insecticide.

5. The method according to claim 4, wherein the organophosphate insecticide is selected from the group consisting of: acephate, azinphos-methyl, chlorfenvinphos, chlorethoxyfos, chlorpyriphos, diazinon, dimethoate, disulfoton, ethoprophos, fenitrothion, fenthion, fenamiphos, fosthiazate, malathion, methamidophos, methidathion, omethoate, oxydemeton-methyl, parathion, parathion-methyl, phorate, phosmet, profenofos, and trichlorfon.

6. The method according to claim 4, wherein the organophosphate insecticide is chlorpyrifos-methyl.

7. The method according to claim 1, wherein the polymer shell is formed by an interfacial polycondensation and the at least one monomer type includes:
at least one oil soluble monomer selected from the group consisting of: diisocyanates, polyisocyanates, diacid chlorides, poly acid chlorides, sulfonyl chlorides, and chloroformates; and
at least one crosslinking agent selected from the group consisting of: diamines, polyamines, water soluble diols and water soluble polyols.

8. The method according to claim 1, wherein the microcapsule shell has a thickness of between about 90 to about 150 nm.

9. The method according to claim 1, wherein the microcapsule shell has a thickness of about 120 nm.

10. The method according to claim 7, wherein the cross-linking agent is diethylenetriamine.

11. A method for controlling an insect population, comprising the steps of:
providing a microencapsulate insecticide comprising:
at least one esterified fatty acid;
at least one organophosphate insecticide; and
and a polymeric microcapsule shell that at least partially encapsulates the insecticide and the esterified fatty acid; and
applying the microcapsule formulation to an area adjacent to a population of insects, wherein the microencapsulated formulation retains its insecticidal activity for at least 120 days after it is applied to the area adjacent to a population of insects.

12. The method according to claim 11, wherein the organophosphate insecticide is selected from the group consisting of: acephate, azinphos-methyl, chlorfenvinphos, chlorethoxyfos, chlorpyriphos, diazinon, dimethoate, disulfoton, ethoprophos, fenitrothion, fenthion, fenamiphos, fosthiazate, malathion, methamidophos, methidathion, omethoate, oxydemeton-methyl, parathion, parathion-methyl, phorate, phosmet, profenofos, and trichlorfon.

13. The method according to claim 11, wherein the organophosphate insecticide is chlorpyrifos-methyl.

14. The method according to claim 11, wherein the capsule wall is formed by a interfacial polycondensation between at least one oil soluble monomer selected from the group consisting of: diisocyanates, polyisocyanates, diacid chlorides, poly acid chlorides, sulfonyl chlorides, and chloroformates; and at least one water soluble monomer selected from the group consisting of: diamines, polyamines, water soluble diols and water soluble polyols.

15. The method according to claim 14, wherein the cross-linking agent is diethylenetriamine.

16. The method according to claim 11, wherein the esterified fatty acid is: A 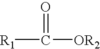
wherein; R₁ is a straight chain or branched alkyl, or alkenyl group having from 11 to 25 carbon atoms, and
R₂ is a straight chain or branched alkyl, or alkenyl group having from 1 to 8 carbon atoms.

17. The method according to claim 16, wherein the esterified fatty acid is methyl oleate.

18. The method according to claim 10, wherein the microcapsule wall has a thickness of between about 90 nm to about 150 nm.

19. The method according to claim 10, wherein the microcapsule has a thickness of about 120 nm.

20. A microencapsulated insecticidal formulation, comprising:
chlorpyrifos-methyl;
methyl oleate; and
and a microcapsule shell, comprising a polyurea.
